(19) United States
(12) Patent Application Publication
(10) Pub. No.: US 2012/0327829 A1
(43) Pub. Date: Dec. 27, 2012

(54) Method and System for Allocating Bandwidth for Data Transmissions Between High-Speed Wireless Devices

(75) Inventor: Rajesh Kumar Sinha, San Diego, CA (US)

(73) Assignee: BROADCOM CORPORATION, Irvine, CA (US)

(21) Appl. No.: 13/168,313

(22) Filed: Jun. 24, 2011

(51) Int. Cl. H04W 72/04; H04W 52/02

(52) U.S. Cl. 370/311; 370/336

(57) ABSTRACT

According to one disclosed embodiment, a method for allocating bandwidth for data transmission time between high-speed wireless devices includes providing beacon intervals to accommodate allocation of data transmissions, each beacon interval including a data transmission time (DTT) interval, dividing all DTT intervals into timeslots of substantially uniform duration, and allocating an integer multiple of the timeslots to each of a plurality of service periods for timed data transmission. Such a method may further include allocating each service period of an isochronous traffic stream to begin the same number of timeslots from the beginning of its beacon interval, dividing the allocation of an asynchronous traffic stream over its allocation period by allocating an equal number of timeslots to a service period in each beacon interval within the allocation period, and de-allocating one or more service periods by marking as unallocated timeslots previously allocated to those service periods.

### BACKGROUND OF THE INVENTION

1. Field of the Invention

The present invention is generally in the field of electronic circuits and systems. More specifically, the present invention is in the field of communications circuits and systems.

2. Background Art

In the field of wireless communications, 60 GHz technology pursues very high throughput in short-range wireless data transmissions, making possible, for example, real-time uncompressed high-definition (HD) video and audio transfers over wireless data networks. To enable this high-speed data transfer, the 60 GHz standard explicitly defines a requirement called an Extended DB and Traffic Specification (TSPEC) for handling and allocating time periods for data transfers between high-speed devices. The TSPEC specifies an allocation period over which the allocation repeats, a minimum allocation time, a maximum allocation time, and a minimum service period duration for each high-speed data transfer. Each complete data transfer is collectively called a traffic stream and each traffic stream may further comprise one or more individual timeframes during which data is transferred, called service periods. Typically, there are two types of traffic: 1) isochronous traffic and 2) asynchronous traffic. Isochronous traffic has an equal time period between each recurrence, whereas asynchronous traffic may not. Further, there are two types of service periods: 1) pseudo-static and 2) non-pseudo static. Pseudo-static service periods recur at the same target transmission time each period, whereas non-pseudo static service periods need not.

A conventional way to manage service period allocation has been to employ the use of multiple linked lists, each list tracking the allocation of scheduled service periods having a particular allocation characteristic in common. For example, one linked list may include all allocated service periods having a pseudo-static nature where all service periods for that traffic stream begin at the same time in each affected beacon interval, where beacon interval may simply be a fixed-length time period, between target beacon transmission times, during which data transmissions may be scheduled to take place between high-speed devices. Another list may include all allocated service periods for traffic streams having non-pseudo-static service periods occurring in multiple beacon intervals. Moreover, a third list may include all allocated service periods where all service periods of that traffic stream are allocated in a single beacon interval, and yet another list may include all remaining unallocated time within the beacon intervals. Using these linked lists, new allocations may be arbitrarily scheduled in portions of the beacon intervals that are currently unallocated. However, using such a conventional approach to identify a suitable location for a new pseudo-static service period, for example, may prove difficult, or even cause the allocation to fail.

Thus, there is a need to overcome the drawbacks and deficiencies in the art by providing a solution allowing more efficient allocation of data requests to each beacon interval in order to avoid failures in allocation of critical data.

### SUMMARY OF THE INVENTION

The present invention is directed to a method and system for allocating bandwidth for data transmissions between high-speed wireless devices, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a system diagram including a control device and a requesting device used in connection with a method for allocating bandwidth for data transmissions between high-speed wireless devices, according to one embodiment of the present invention;

FIG. 2 shows a flowchart describing steps taken to implement a method for allocating bandwidth for data transmissions between high-speed wireless devices, according to an embodiment of the present invention;

FIG. 3a shows a timing diagram denoting the operation of a method for allocating bandwidth for data transmissions between high-speed wireless devices, according to an embodiment of the present invention; and

FIG. 3b shows multiple allocation arrays associated with the timing diagram of FIG. 3a denoting the operation of a method for allocating bandwidth for data transmissions between high-speed wireless devices, according to an embodiment of the present invention.

### DETAILED DESCRIPTION OF THE INVENTION

The present invention is directed to a method and system for allocating bandwidth for data transmissions between high-speed wireless devices. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings. It should be understood that unless noted otherwise, like or corresponding elements among the figures may be indicated by like or corresponding reference numerals. Moreover, the drawings and illustrations in the present application are generally not to scale, and are not intended to correspond to actual relative dimensions.

In a conventional 60 GHz data technology system, a traffic stream is established between one or more requesting devices and a control device. The control device will carry out service period allocation as one of its assigned roles. A requesting device sends a data request including a Traffic Specification (TSPEC), which defines the timing and traffic requirements of the data request. The data request may be received by the control device, and a scheduler within the control device may schedule one or more service periods during which the requested data will be transmitted to the receiving device. The device that initiates a traffic stream creation request may be the source of transmitted data. The scheduler keeps track of all allocated service periods and does admission control based on available bandwidth. The scheduler will construct future allocations in advance based on the scheduling information available. Because different requesting devices may have different allocation requirements, the control device scheduler must effectively manage the bandwidth and accommodate as many service periods as possible.

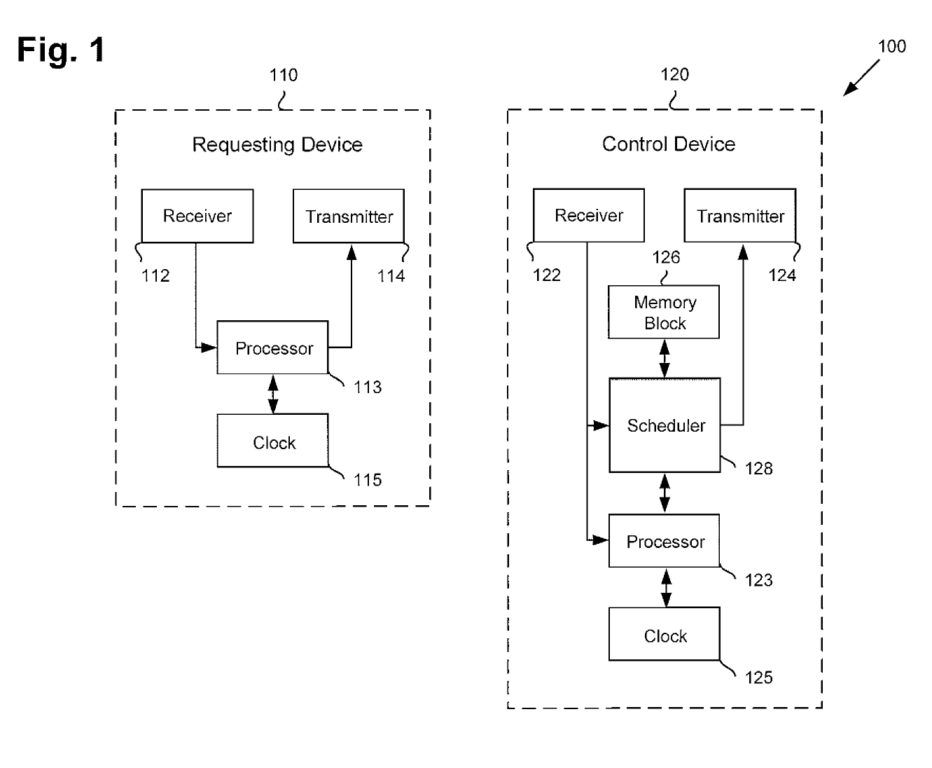

FIG. 1 shows system 100 for allocating bandwidth for data transmissions between high-speed wireless devices, according to one embodiment of the present invention, which is capable of overcoming the drawbacks and deficiencies identified with the conventional art. In one embodiment, the system may utilize a WGA 60 GHz wireless specification when transmitting data between devices. According to the embodiment of FIG. 1, system 100 is configured to include at least control device 120, which is shown in FIG. 1 in combination with requesting device 110. Control device 120 may comprise, for example, receiver 122, processor 123, transmitter 124, clock 125, memory block 126 and scheduler 128. In one embodiment, control device 120 may be a 60 GHz personal basic service set control point (PCP) device, for example. Receiver 122 may be configured to receive one or more requests for data from Requesting Device 110. Transmitter 124 may be connected to scheduler 128 and may be configured to periodically transmit data embedded within one or more beacon intervals to one or more requesting devices, such as requesting device 110. Clock 125 may be connected to processor 123 and may enable control device 120 to track timing intervals necessary to the operation of one or more embodiments of the present invention.

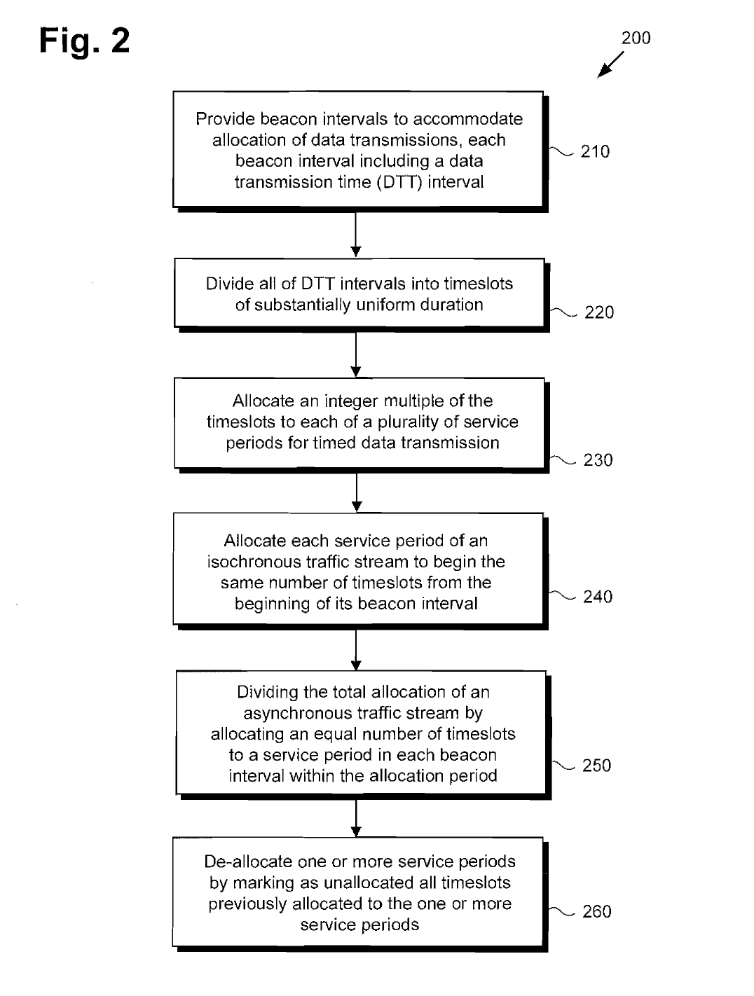

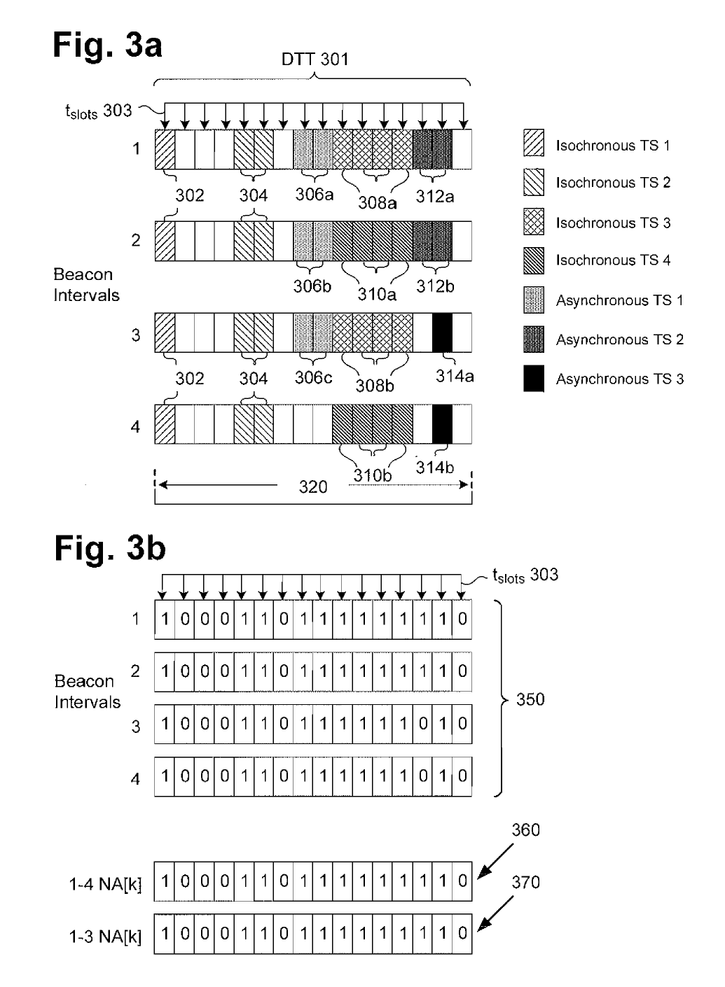

Scheduler 128, connected to memory block 126, receiver 122, transmitter 124 and processor 123, may be configured to optimally schedule timed data transmissions during one or more beacon intervals, according to embodiments of the present invention. Memory block 126, connected to scheduler 128, may be configured to maintain linked lists and/or allocation arrays containing allocation information for each service period, according to one or more embodiments of the present invention, which will be described in greater depth in connection with FIGS. 2, 3a and 3b. It should be understood that although FIG. 1 discloses requesting device 110 and control device 120, the present invention may also include embodiments in which requesting device 110 may also include the necessary features to allow it to act as a control device, thus allowing either high-speed device in the system to act as a control device and send data transmissions to the other device when required. Data transmissions may also be between two requesting devices. In such a case, the control device may handle the scheduling and allocation of the bandwidth needed by reserving service periods in beacon intervals as required. The reserved bandwidth information is communicated as part of an Extended Schedule included in the beacon frame to each of the requesting devices. At the scheduled time, the data transmission may then take place between the two requesting devices.

According to the embodiment shown in FIG. 1, requesting Device 110 comprises receiver 112, processor 113, transmitter 114 and clock 115, and may be configured to initiate one or more requests for data and receive timed data transmissions embedded within one or more beacon intervals. Within requesting device 110, receiver 112 may be connected to processor 113 and may be configured to receive timed data transmissions from another device, for example, control device 120, in the form of multiple service periods embedded in one or more beacon intervals. Transmitter 114 may also be connected to processor 113 and may be configured to transmit one or more requests for data transmission to another device, for example, control device 120. Clock 115 may be connected to processor 113 and may enable requesting device 110 to track timing intervals necessary to the operation of one or more embodiments of the present invention.

The operation of system 100 will be further described by reference to FIGS. 2, 3a and 3b. FIG. 2 shows a flowchart presenting steps taken to implement a method for allocating bandwidth for data transmissions between high-speed wireless devices, according to one embodiment of the present invention, while FIGS. 3a and 3b show a timing diagram and allocation arrays, respectively, further describing the operation of a system utilizing a method according to one or more embodiments of the present invention. With respect to FIG. 2, it is noted that certain details and features have been left out of flowchart 200 that are apparent to a person of ordinary skill in the art. For example, a step may comprise one or more substeps, as known in the art. While steps 210 through 260 indicated in flowchart 200 are sufficient to describe at least one embodiment of the present method, other embodiments may utilize steps different from those shown in flowchart 200, or may include more, or fewer steps.

According to WGA 60 GHz wireless specification, a beacon interval is simply a fixed-length time period during which data transmissions may be scheduled to take place between high-speed devices, such as requesting device 110 and control device 120 of FIG. 1. As shown in FIG. 2, step 210 of flowchart 200 comprises providing a plurality of beacon intervals to accommodate allocation of data transmissions, each beacon interval including a data transmission time (DTT) interval. Referring, for example, to FIG. 1, step 210 may be performed by control device 120 in anticipation of receipt of one or more requests for data transmission from requesting device 110. An example of typical beacon intervals is illustrated in FIG. 3a as beacon intervals 1 through 4. Each beacon interval may have length or duration 320 of approximately 100 milliseconds, for example. However, one of ordinary skill would appreciate that a beacon interval may be longer or shorter than 100 milliseconds, depending on the particular requirements of the application.

In this novel approach, according to an embodiment of the present invention, the entire DTT period 301 of a beacon interval may be divided into timeslots 303 of substantially uniform duration, tₛₗₒₜ. Each tₛₗₒₜ duration timeslot 303 of DTT period 301 is a bandwidth slice whose resolution may be decided based on the requirement of the particular application. The duration of each timeslot 303, may be 1 millisecond, for example. However, one of ordinary skill would appreciate that this duration may be more or less than 1 millisecond, based on the particular requirements of the application. Because entire DTT period 301 may be divided into timeslots 303, each DTT period 301 may comprise N timeslots 303, where N=DTT/tₛₗₒₜ. If DTT period 301 is equal to the entire beacon interval (BI) length 320, as is the case for the example shown in FIG. 3a, then N=BI/tₛₗₒₜ. This may be illustrated by step 220 of FIG. 2 as well as FIG. 3a where beacon intervals 1 through 4 may each comprise DTT period 301 spanning substantially the entire beacon interval duration 320, each DTT period 301 of beacon intervals 1 through 4 being further divided into discrete timeslots 303. According to the the embodiment shown in FIG. 1, for example, step 220 may be performed by control device 120.

Once the DTT period within each beacon interval has been divided into timeslots of substantially uniform length, allocation of one or more data transmissions into service periods may commence. As disclosed in step 230 of FIG. 2, an integer multiple of timeslots 303 may be allocated to each of a plurality of service periods for timed data transmission. In this novel approach, service period allocation will always be in integer multiples of the timeslot duration tₛₗₒₜ, e.g., each timeslot 303 may be allocated to only one service period, even if data is not actually transferred during the entire timeslot. According to the the embodiment shown in FIG. 1, for example, step 230 may be performed by control device 120. One or more requesting devices 110 may also be configured to receive the plurality of service periods within each of the beacon intervals.

In order to more efficiently manage the allocation of the plurality of service periods into multiple beacon intervals, scheduler 128 in concert with memory block 126 and processor 123, for example, may represent the timeslots in actual implementation as a two dimensional array A[M_{BI}][Nₛₗₒₜₛ] which may represent the status of each timeslot as either allocated or not allocated by an array cell value of either 1 or 0, respectively. In this instance, M_{BI} is the total number of future beacon intervals that the scheduler 128 may allocate, and Nₛₗₒₜₛ is the total number of timeslots in each beacon interval. Thus, A[2][13]=1 would indicate that the 13^{th} timeslot in the second beacon interval in future from the current beacon interval is currently allocated, for example. FIG. 3b illustrates this concept through array 350. Each row and column of array 350 may correspond to a particular beacon interval and timeslot, respectively, in FIG. 3a. The value of M_{BI}, and the total number of future beacon intervals that scheduler 128 may allocate, may be chosen according to the requirements of the particular application to which this method may be applied.

As was previously stated, each request for data transmission typically includes a TSPEC, which specifies an allocation period over which an allocation repeats, a minimum allocation time, a maximum allocation time, and a minimum service period duration for each high-speed data transfer, or traffic stream. In the case of isochronous traffic streams, the traffic stream is periodic, in other words, data transmission has an equal time period between known, periodic recurrences. Further, because the service periods of isochronous traffic streams are pseudo-static, each service period must recur at the same target transmission time each period. Thus, each service period should be allocated to recur according to its allocation period, and should also be restricted to begin the same number of timeslots from the beginning of its beacon interval. Though scheduler 128 may be free to position the service periods that make up the isochronous traffic stream anywhere in the allocation period, step 240 of FIG. 2 for the present method attempts to allocate all data in an isochronous traffic stream to a single service period during each allocation period of the isochronous traffic stream.

In order to successfully allocate an isochronous traffic stream, a determination can be made as to whether enough bandwidth is available to accommodate the traffic stream in the allocation array A [M_{BI}][Nₛₗₒₜₛ] such as allocation array 350, for example. The minimum allocation time for a particular isochronous traffic stream is defined by its associated TSPEC. This value is the minimum time required to transfer the required data for that traffic stream each allocation period. Thus, this minimum allocation time should be unallocated and available in a given target beacon interval. The unallocated time of a target beacon interval may be determined by multiplying each timeslot allocation status 303 in the row of the allocation array A[M_{BI}][Nₛₗₒₜₛ] corresponding to the target beacon interval by the timeslot duration tₛₗₒₜ, summing all of those time values, and subtracting the sum from the DTT period for that beacon interval. If this final value is larger than the minimum allocation time defined in the TSPEC, enough unallocated time exists in the target beacon interval to permit allocation of a service period there.

However, each traffic stream may also be predefined to have a minimum service period duration. This can be the minimum duration for which a service period of that particular traffic stream may be allocated in any beacon interval, for example. Thus, a service period for an isochronous traffic stream may be allocated if each beacon interval in which the allocation is required contains a sufficient number of contiguous, vacant timeslots in the same positions, to accommodate the minimum service period duration requirement of that isochronous traffic stream.

This may be implemented by a two step process, for example. First, scheduler 128 must determine which slots arc unallocated in each beacon interval in which a service period will he required for a particular isochronous traffic stream. This determination may be facilitated by the creation of a net allocation array NA[k], where NA[k] is a one dimensional array that represents an aggregate representation of how the timeslots are allocated for all affected future beacon intervals for all currently active traffic streams. For example, NA[k]=0 means that every k^{th} timeslot in every affected beacon interval is unallocated. Contrarily, NA[k]=1 can mean that at least 1 of the k^{th} timeslots in the affected beacon intervals, based on the allocation period, is allocated, and thus, a service period for an isochronous traffic stream may not be allocated to this timeslot in any of the affected beacon intervals. Net allocation arrays 360 and 370 of FIG. 3b are examples of such an array.

Net allocation array 360 holds an aggregate representation of the net allocation of beacon intervals 1-4 corresponding to both FIG. 3a and the associated allocation array 350 in FIG. 3b. In order to determine the net allocation of the timeslots in beacon intervals 1-4, for example, an embodiment present invention begins by setting all cells of net allocation array 360 to zero. Next, the first timeslot in row 1 of allocation array 350, is compared to the first timeslot of net allocation array 360, using a logical OR operation for example. Thus, if either cell contains a value of 1, the first cell of net allocation array 360 may be given a value of 1. A similar comparison can then be done with the first timeslot in each affected beacon interval, in this example, beacon intervals 2-4. Once a comparison has been made with the first timeslot of the last affected beacon interval, the comparison process can be repeated using the next timeslot in each affected beacon interval and the next timeslot in net allocation array 360. Thus, after each timeslot of each affected beacon interval of allocation array 350 has been compared to each timeslot of net allocation array 360, net allocation array 360 will typically contain a value of 0 in any timeslot where all affected beacon intervals have that timeslot unallocated, and a value of 1 where any one of the affected beacon intervals contains an allocation in that timeslot.

Scheduler 128 may now determine if there are enough contiguous, vacant timeslots in net allocation array 360 to allocate the service periods predefined by a minimum service period duration. For example, if an isochronous traffic stream has a defined minimum service period duration equal to 3 timeslots, scheduler 128 may next determine whether net allocation array 360 contains at least 3 contiguous, vacant timeslots. If so, the isochronous traffic stream may be allocated in those timeslots in each affected beacon interval starting with the first timeslot of those contiguous, vacant timeslots. If not, no service periods may be allocated for that isochronous traffic stream. This may be accomplished, by scheduler 128 for example, by beginning at the first timeslot of net allocation array 360 and incrementing a counter, initially set to zero, if the timeslot carries a value of 0 and alternatively resetting the counter to 0 if the timeslot carries a value of 1. Scheduler 128 may then move to the next timeslot and repeats this operation. This is continued until the last timeslot of net allocation array 360 has been compared, or in the alternative, until the counter has reached the predefined minimum service period duration required for allocation. If the required allocation time is not found, the above 2 step process may be repeated after incrementing the starting beacon interval, i.e determining the net allocation array NA[k] starting with beacon interval 2, then if necessary, starting with beacon interval 3 and so on.

The effect of the above allocation submethod on allocation of service periods for isochronous traffic streams is disclosed in FIG. 3a. As can be seen, isochronous traffic streams (TS) 1 and 2, comprised of service periods 302 and 304, respectively, each have an allocation period of one beacon interval, e.g, isochronous TS 1 and isochronous TS 2 must be transmitted using no more than one beacon interval. It is noted that the appearance of isochronous TS 1 302 and isochronous TS 2 304 in each of future beacon intervals 1 through 4 simply indicates that those isonchronous traffic streams are repeated in each beacon interval. Further, isochronous TS 3 and isochronous TS 4, comprised of service periods 308a and 308b, and 310a and 310b, respectively, each have allocation periods of two beacon intervals, e.g, isochronous TS 3 and isochronous TS 4 must be transmitted using no more than two beacon intervals and are thus allocated in alternating fashion as service periods 308a, 310a, 308b and 310b over respective beacon intervals 1 through 4. It is further noted that each service period for a given isochronous TS begins at the same timeslot in each respective beacon interval.

Continuing to step 250 of FIG. 2, scheduler 128 may divide a total allocation of an asynchronous traffic stream by allocating an equal number of timeslots to a service period in each beacon interval within the allocation period of that asynchronous traffic stream. However, each allocated service period must typically also have a duration of at least a predefined minimum service period duration according to the TSPEC for that traffic stream. Thus, if dividing an asynchronous traffic stream into a service period allocation in each beacon interval within that traffic stream's allocation period would result in service periods of a duration less than a predefined minimum service period duration, the asynchronous traffic stream may be reallocated over one less beacon interval until the duration of each allocated service period for that traffic stream has a duration of at least the required minimum service period duration. In the alternative, the allocation period of the asynchronous traffic stream may be directly recalculated to be equal to the minimum allocation of the entire traffic stream divided by the minimum service period duration, rounded down to the nearest integer multiple of beacon intervals. In either case, the allocation period of the asynchronous traffic stream may be readjusted to ensure service periods of at least a predefined minimum service period duration.

Additionally, in an embodiment of the present method it may be preferred to allocate each service period of the asynchronous traffic stream such that each service period begins the same number of timeslots from the beginning of its respective beacon interval. Thus, once the proper allocation period of the asynchronous traffic stream has been determined, as described above, service periods for an asynchronous traffic stream may be allocated if each beacon interval in which the allocation is required contains a sufficient number of contiguous, vacant timeslots in the same positions, to accommodate the minimum service period duration requirement of that asynchronous traffic stream using the same net allocation array procedure as described above for isochronous traffic streams. A difference being that the beacon intervals over which the net allocation array is constructed are a number of contiguous beacon intervals equal to the adjusted allocation period for the asynchronous traffic stream. Net allocation array 370 of FIG. 3b compares beacon intervals 1-3 in this manner, for example.

The effect of the above allocation submethod on allocation of service periods for asynchronous traffic streams is also disclosed in FIG. 3a. As can be seen, asynchronous TS 1 comprised of service periods 306a, 306b and 306c has an allocation period of 3 beacon intervals and a minimum service period duration of 2 timeslots, for example. Further, asynchronous TS 2 comprised of service periods 312a and 312b has an allocation period of 2 beacon intervals and a minimum service period duration of 2 timeslots, for example. Finally, asynchronous TS 3 comprised of service periods 314a and 314b has an allocation period of 2 beacon intervals but a minimum service period duration of just 1 timeslot. Notice that each service period for a given asynchronous traffic stream also begins at the same timeslot offset in each respective beacon interval, just as the isochronous traffic stream service periods.

To keep track of future allocations, scheduler 128 may maintain a linked list of allocated service period structures for all allocated beacon intervals. This list may be stored in memory block 126, for example. The linked list may include, for each allocated service period, a start time offset from the beginning of a respective DTT interval and/or a duration of the allocation and a TSPEC for the traffic stream of which each service period is a part, for example. The linked list for each beacon interval may be sorted in order of service period start time within that beacon interval, allowing scheduler 128 to browse the allocations for the current beacon interval and include them in an extended schedule element sent to involved receiving devices, device 110, for example.

In certain instances a traffic stream may need to be deleted, and its included service periods de-allocated. Upon receipt of a request to delete a traffic stream, scheduler 128 may browse the linked list of service period allocations and mark as unallocated the corresponding timeslots of one or more service periods previously allocated for that particular traffic stream. Step 260 of FIG. 2 discloses such a step. This may be carried out, for example, by receiving the TSPEC which needs to be deleted and scheduler 128 browsing through the allocation list for each future beacon interval, searching for each service period entry matching the particular TSPEC. For each matching service period, scheduler 128 may mark all corresponding timeslots in allocation array 350, for example, as unallocated and remove the corresponding entries from the linked list.

In certain applications it may also be desirable to initiate a sleep mode, or define a wakeup schedule, during which one or more devices may not be required to “listen” for transmitted data, or after which a device may awaken. Also, there may be a traffic stream scheduling constraint (TSCONST) associated with a TS creation request from a device, such as receiving device 110, for example. In such a case, allocation of service periods during a sleep mode or scheduling constraint duration timeframe may be prevented by marking all timeslots within the timeframe as allocated, in the allocation array 350, before scheduling any service periods into affected beacon intervals.

Thus, the present invention, according to various embodiments, allows allocating bandwidth for data transmissions between high-speed wireless devices while minimizing or eliminating unusable data transmission time within beacon intervals in high-speed wireless data transmissions. Conventional methods have been incapable of guaranteeing proper allocation of all admitted service periods within fixed-time beacon interval periods, however, the present invention, according to its various embodiments, addresses and overcomes these problems in the conventional art.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

What is claimed is:

1. A method for allocating bandwidth for data transmissions between high-speed wireless devices, the method comprising:
providing beacon intervals to accommodate allocation of the data transmissions, each beacon interval including a data transmission time (DTT) interval;
dividing all of the DTT intervals into timeslots of substantially uniform duration; and
allocating an integer multiple of the timeslots to each of a plurality of service periods for timed data transmission.

2. The method of claim 1, further comprising configuring a requesting device to receive the plurality of service periods within the beacon intervals.

3. The method of claim 1, wherein the data transmissions conform to a WGA 60 GHz wireless specification.

4. The method of claim 1, further comprising allocating each service period of an isochronous traffic stream to begin the same number of timeslots from the beginning of its beacon interval.

5. The method of claim 1, further comprising allocating all data in an isochronous traffic stream to a single service period during each allocation period of the isochronous traffic stream.

6. The method of claim 1, further comprising allocating a service period for an isochronous traffic stream only if each beacon interval in which the allocation is required contains a sufficient number of contiguous, vacant timeslots in the same positions, to accommodate a minimum allocation requirement of the isochronous traffic stream.

7. The method of claim 1, further comprising dividing the total allocation of an asynchronous traffic stream equally over its allocation period by allocating an equal number of timeslots to a service period in each beacon interval within the allocation period.

8. The method of claim 7, wherein each service period of the asynchronous traffic stream begins the same number of timeslots from the beginning of its respective beacon interval.

9. The method of claim 7, wherein the asynchronous traffic stream is reallocated over one less beacon interval if not doing so would result in each service period of the asynchronous traffic stream having a shorter duration than a predefined minimum service period duration.

10. The method of claim 1, further comprising preventing allocation of service periods during a sleep mode or scheduling constraint timeframe by marking all timeslots within the timeframe as allocated before scheduling service periods to a beacon interval.

11. The method of claim 1, further comprising de-allocating one or more service periods by marking as unallocated timeslots previously allocated to the one or more service periods.

12. The method of claim 1, wherein each service period allocation within the beacon intervals is maintained in a linked list, the linked list including for each service period:
a start time offset from the beginning of the DTT interval;
a duration of the allocation; and
a traffic specification.

13. The method of claim 12, wherein the linked list is sorted in order of starting time offset.

14. The method of claim 1, wherein the substantially uniform duration of the timeslots is determined to meet the needs of an application of the method.

15. The method of claim 1, wherein the substantially uniform duration of the timeslots is 1 millisecond.

16. The method of claim 1, wherein the beacon intervals are each approximately 100 ms in length.

17. A system for allocating bandwidth for data transmissions between high-speed wireless devices, the system comprising:
a control device including a receiver, a transmitter and a scheduling algorithm module;
the control device configured to:
provide beacon intervals to accommodate allocation of the data transmissions, each beacon interval including a data transmission time (DTT) interval;
divide all of the DTT intervals into timeslots of substantially uniform duration; and
allocate an integer multiple of the timeslots to each of a plurality of service periods for timed data transmission.

18. The system of claim 17, wherein the control device is a 60 GHz personal basic service set control point (PCP) device.

19. The system of claim 17, further comprising a requesting device configured to receive the plurality of service periods within the beacon intervals.

20. The system of claim 17, wherein the system utilizes a WGA 60 GHz wireless specification.
